(19) United States
(12) Patent Application Publication
(10) Pub. No.: US 2010/0064220 A1
(43) Pub. Date: Mar. 11, 2010

(54) METHOD AND SYSTEM FOR PROVIDING INTERACTIVE HYPERLINKED VIDEO

(75) Inventor: Ramakrishnan R. Sankaranarayan, Chennai (IN)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES INDIA PRIVATE LIMITED, Guindy (IN)

(21) Appl. No.: 12/056,728

(22) Filed: Mar. 27, 2008

(51) Int. Cl. G06F 3/00

(52) U.S. Cl. 715/719

(57) ABSTRACT

An approach is provided for enabling interactive hyperlinked video. A hyperlink is generated and specifies an action that is performed upon activation of the hyperlink. The hyperlink is embedded in a video stream.

### BACKGROUND INFORMATION

Multimedia communication, information and entertainment have expanded greatly in recent years with the advent of more technically advanced televisions, personal computers, and other communication and entertainment devices. As multimedia communication has increased in complexity and varying degrees of integration with television, cable, on-demand systems, the Internet, etc., the quantity and variety of service offerings to the user have significantly increased. Traditionally, such multimedia systems have pushed audio/visual information to a user (or subscriber), with little or no two-way communication between the user and the service provider. As a consequence, the user experience is limited and is dictated solely by the provider of the services.

Therefore, there is a need for an approach to improve user interaction with multimedia sources of audio/visual information.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a communication system capable of providing interactive video services, according to an exemplary embodiment;

FIG. 2 is a diagram of a service provider network configured to provide interactive video services, according to an exemplary embodiment;

FIG. 3 is a flowchart of a process for providing hyperlinked interactive video, according to an exemplary embodiment;

FIGS. 4A-4C are diagrams of exemplary video frames containing embedded hyperlinks, according to various embodiments; and

FIG. 5 is a diagram of a computer system that can be used to implement various exemplary embodiments.

### DESCRIPTION OF PREFERRED EMBODIMENTS

An apparatus, method, and software for providing hyperlinked interactive video services are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

Although the various exemplary embodiments are described with respect to a data network and the Real Time Streaming Protocol (RTSP), it is contemplated that these embodiments have applicability to any two-way communication systems and equivalent protocols.

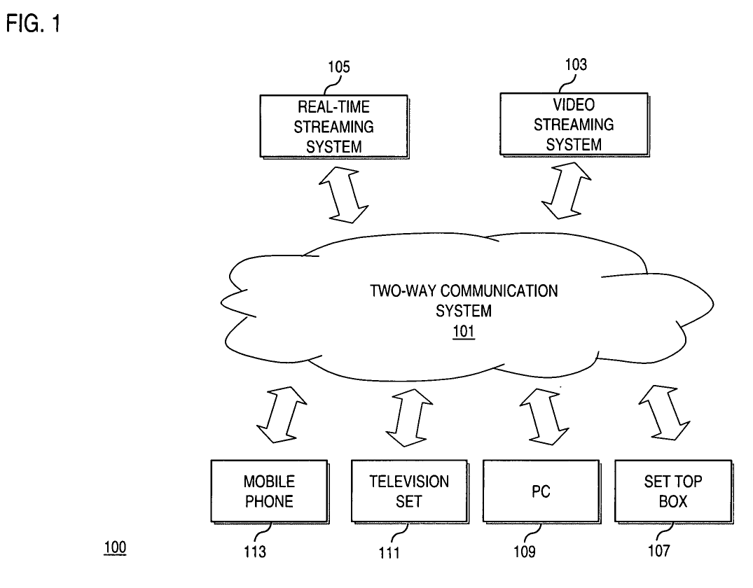

FIG. 1 is a diagram of a communication system capable of providing interactive video services, according to an exemplary embodiment. It is recognized that the user experience can be greatly enhanced by providing more interactivity (i.e., control) between users and the media content itself. For the purposes of illustration, the system 100 is explained in the context of video content—i.e., interactive video. The video, containing the hyperlinks, allows users to direct the flow of the video. As seen in FIG. 1, a two-way communication network 101 includes, on the network side, a video streaming system 103 along with a real-time streaming system 105. According to one embodiment, the real-time streaming system 105 employs the Real Time Streaming Protocol (RTSP) for enabling on-demand delivery of real-time media, such as video streams and audio streams, and playback control (e.g., “play,” “fast forward,” “review,” “pause”). RSTP is more fully described in Internet Engineering Task Force (IETF) Request for Comment (RFC) 2326, which is incorporated herein by reference in its entirety. In this manner, any number of communication devices with a capability to receive video signals can be provided with a hyperlinked interactive video service. By way of example, these devices include a set-top box 107, a personal computer (PC) 109, a television set 111, and a mobile phone 113. Effectively, the devices 107-113 can access and control the video streaming system 103 to access video files stored within the system 103.

In an exemplary embodiment, the system 100 can include a conglomeration of networks—e.g., a Transmission Control Protocol/Internet Protocol (TCP/IP) network, a radio communication system, a satellite network, a cable system, etc. Moreover, the radio communication system can utilize any type of technology, such as Global System for Mobile Communications (GSM), Code Division Multiple Access (CDMA), 3^{rd} Generation (3G) and 4^{th} Generation (4G) standards. The system 100 supports establishment of communication sessions between the video streaming system 103 (in conjunction with the real-time streaming system 105) and one or more of the devices 107-113.

The two-way communication system 100 can thus support a video transmission session that permits a user to control the video stream; additionally, other interactive features can be provided, as later explained. In an exemplary embodiment, this process entails establishment of an RTSP session, in which the system 103 and the requesting device (such as the set-top box 107) to exchange or negotiate information about the session. Such information exchange may occur at any time prior to, or even during, the actual playing of the audio/visual stream. This information may include the format of the audio and video that is to be streamed, the bit-rate of the audio and video, etc.

Furthermore, there is an added capability of exchanging information about various pieces of interactive “hotspots” in the session that is being set up. As such, the session setup can also include the exchange of information about hyperlinks in the video; such information is referred to herein as “interactivity information” or metadata. These hyperlinks can be areas within the video that are associated with an action that the user can engage in. The action can involve access to other media content or communication services. The information that is exchanged may include, for example, timestamps of the different video frames indicative of when hyperlinks are displayed, when such hyperlinks start and when they stop showing on the display screen of the communication device, the area of the screen the hyperlinks will cover, the manner in which such hyperlinks will highlight themselves or expect themselves to be highlighted by another communication device, the display properties of the hyperlinks when they are highlighted by the user and when they are not highlighted by the user though displayed on the screen of a communication device, the action associated with the hyperlink when “clicked on” or otherwise activated by the user, etc.

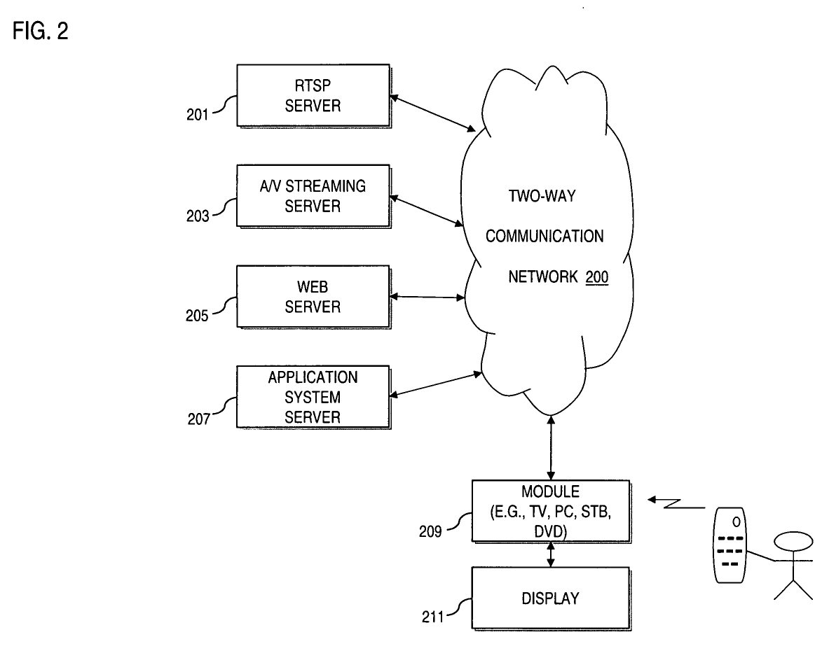

Similar to adding hyperlinks to web pages, the hyperlinks that are embedded in the video permits a user to access other portions of the video or link to other media altogether. This capability permits a service provider to offer a power feature to subscribers, thereby generating new sources of revenue. One exemplary scenario in which a service provider can operate to offer the hyperlinked interactive video service is shown in FIG. 2.

FIG. 2 is a diagram of a service provider network configured to provide interactive video services, according to an exemplary embodiment. A communication system 200 provides video and/or audio services to users via set-top boxes 201a-201n over transmission facility, such as a data communication infrastructure (e.g., Internet Protocol (IP)-based applications and systems) 203. In addition, any one of the set-top boxes 201a can also be directly linked to the service provider network 205, as shown for the set-top box 201a; such a link can be, for example, coaxial cable, optical cable, etc. It is noted that other customer premises equipment (CPE) can be utilized to support these services. Video streams can thus be transmitted into every subscriber's premises, and such video streams, in an exemplary embodiment, can be personalized, as more fully described below. Such video services may be employed, for example, in interactive television (TV), video advertising, and on-line marketplace applications for “TV-commerce.”

In one embodiment, the set-top boxes 201a-201n provide a Voice over IP (VoIP) function, an IP television (IPTV) function, and an online web browsing function. The service provider network 205 includes an administrator system 206 for operational and management functions to deploy the audio/video services, using an IPTV system 207. The service provider network 205 also has connectivity to a public data network 209, such as the global Internet (or World Wide Web), as well as a radio network 210.

The radio network 210, in an exemplary embodiment, is a cellular network that can utilize any modulation and access technology (e.g., spread spectrum (CDMA), GSM, 3G, 4G, etc.) that can support audio and video streaming. The radio network 210 can service one or more mobile devices 211; these devices 211, as with the set-top boxes 201a-201n, can receive video streams with the embedded hyperlinks.

The packet based network 203, in turn, can communicate with a public switched telephone network (PSTN) 212 for receiving and terminating calls. The IPTV system 207 can receive content from television broadcast systems 213 and other content provider systems 215.

The IPTV system 207 supports the transmission of television video programs from the broadcast systems 213 as well as other content, such as video-on-demand services, from the content provider systems 215, using Internet Protocol (IP). That is, the IPTV system 207 delivers video streams in form of IP packets. Use of IP permits television service to be integrated with a broadband Internet services, and thus, share common connections to the customer premise. Also, IP packets can be more readily manipulated, and therefore, provide users with greater flexibility in terms of control.

In one embodiment, the service provider network 205 provides unicast transmission of the video streams. Unlike a broadcast transmission, where simultaneous transmission of a single message to all hosts on a broadcast domain is made, and a multicast transmission, which sends a message to a select list of hosts on a network (i.e., both broadcast and multicast transmissions have a single transmitter and multiple receivers), a unicast transmission is a communication between a single sender and a single receiver over a network. Because of the unicast nature of the transmission, the transmission can thus be personalized by streaming separate, tailored single streams to the subscribers. Accordingly, hyperlinks associated with the particular video stream can be displayed to a specific user, such that the video transmission can be tailored differently for different subscribers.

Because video content is bandwidth intensive, the transmission facilities to the set-top boxes 201a-201n can utilize fiber optic cables or other high capacity transmission media (e.g., Digital Subscriber Line (DSL) connections, cable television connections, etc.). Delivery of the video content, by way of example, is through a multicast from the IPTV system 207 to the set-top boxes 201. To tune to a channel, the set-top box 201a simply joins a multicast of the video content, using an IP Group Membership Protocol (IGMP) protocol (e.g., IGMP v2) to join a new multicast group, for example. This manner of video delivery avoids the need for expensive tuners to view television broadcasts however, other video delivery methods, such as cable, can be used. Also, the video content can be provided to various IP-enabled devices, such as personal computers (PC), personal digital assistants (PDAs), web-appliances, mobile phones, etc.

The set-top box 201 integrates all the functions of IPTV and VoIP, as well as online web browsing functions in a manner that seamlessly toggles among these functions.

In general, IP telephony, which is also referred to as Voice-over-IP (VoIP), is the conversion of voice information into data packets that are transmitted over an IP network. Four possible scenarios exist with the placement of a VoIP call: (1) phone-to-phone, (2) phone-to-set-top box, (3) set-top box-to-phone, and (4) set-top box-to-set-top box. In the first scenario of phone-to-phone call establishment, a call from a phone (not shown) is switched through PSTN 212 by a switch to a, e.g., voice gateway (not shown) of the packet based network 203. The packetized voice call is then routed to terminate at a VoIP phone. Under the second scenario, the phone places a call to a set-top box 201a through the PSTN 212. This voice call is then switched by the packet based network 203, which forwards the voice call to a set-top box 201a. The third scenario involves the set-top box 201a placing a call to a voice station. Using a voice encoder (not shown), the set-top box 201a introduces a stream of voice packets into the packet based network 203. The voice gateway (not shown) converts the packetized voice information into a POTS (Plain Old Telephone Service) electrical signal, which is circuit switched to the voice station (e.g., phone). Lastly, in the fourth scenario, the set-top box 201a establishes a voice call with another set-top box 201b; in this case, packetized voice data is transmitted from the set-top box 201a via the packet based network 203 to the other set-top box 201a, where the packetized voice data is decoded.

To provide interactive hyperlinked video, the service provider network 205 utilizes, in accordance with one embodiment, an application server 217, a web server 219, an audio/video (A/V) streaming server 221, and an RTSP server 223. These resources 217, 219, 221, and 223 permit a user using an input device 225, e.g., a remote control device, to interact with a video program streamed by the A/V streaming server 221 to potentially access other media content, e.g., World Wide Web resources via the web server 219, as well as other telephony services via the application server 217. Other types of input devices include a mouse, pointer, touch tablet, key pad, etc. In addition, the remote control device 225 can include buttons corresponding to such functions as play, pause, fast forward, rewind, etc. The application server 217 can interact with the internal application resident in, for example, the set-top boxes 201 of mobile device 211, to execute tasks such as download bitmaps, handling billing for purchased products, etc., or other tasks that result as a consequence of performing actions associated with selected hyperlinks.

The remote control device 225, in an exemplary embodiment, can include controls to select, or activate, any hyperlink that may be visible on the playing video program. As noted, the set-up of the video streaming includes the exchange of information about the hyperlinks in the video. For example, during the video session establishment or playing of the video, information about the hyperlinks may be exchanged between the RTSP server 223 and the particular device, e.g., set-top box 201a. The interactivity information may include, for example, the time and location within the video such hyperlinks are to be displayed (e.g., the timeframe within the video and the specific location on the frame, e.g., left, right, top, bottom), the length of time such hyperlinks should be displayed, the specific manner in which the hyperlinks are to be displayed (e.g., highlighted). This type of information may be specified, for example, by the content creator or it may be predetermined (e.g., specified in an agreement between the service provider and the subscriber). Other information may include, for example, the manner in which the video containing the displayed hyperlinks is to behave. For instance, it may be predetermined that when a hyperlink is displayed, the video is to pause so as to give a user time to consider how to respond before the video proceeds further. Alternatively, it might be predetermined that when a hyperlink is displayed, the video plays at normal speed, or at a slow speed, or some other variable speed. These are some exemplary options that may be included by the content creator, by the service provider and/or by the user.

The hyperlinks can be areas, marked by geometric information, for example, associated with an action that can be performed based on applications supported by the set-top boxes 201a-201n and the service provider network 205. The hyperlink may be, for example, a link to a telephone number, a website, another portion of the playing video, a portion of a different video, or a specialized user interface (e.g., graphics and/or text) that is displayed on the communication device display, and the like.

Moreover, it is contemplated that the hyperlinks can provide interactive advertisements or promotional videos. Thus, the service provider network 205 communicates with an advisement system 227, which supplies advertisement materials that are correlated with the hyperlinks. With respect to interactive ads, the advertisements can be partitioned into sections. One section can be utilized to permit the user to navigate the through ads based on the user's interest and convenience to view products. Alternatively, another section can be customized advertisements so that they can be localized or customized according to either pre programmed user interests or already known user characteristics (e.g., interests, behavioral parameters, location, income category etc.).

As mentioned, the interactive hyperlink video service can additionally provide an interactive marketplace. For example, a virtual interactive market place of products can be setup by the service provider, wherein, advertisers can produce interactive ads or promotional videos of specific products that are to be displayed in the marketplace. The service provider can assess a charge for displaying these interactive ads or promotional videos. In addition, the service provider can charge for click to dial calls that are made for purchases that are transacted through a web URL or a web service associated with the video hyperlinks.

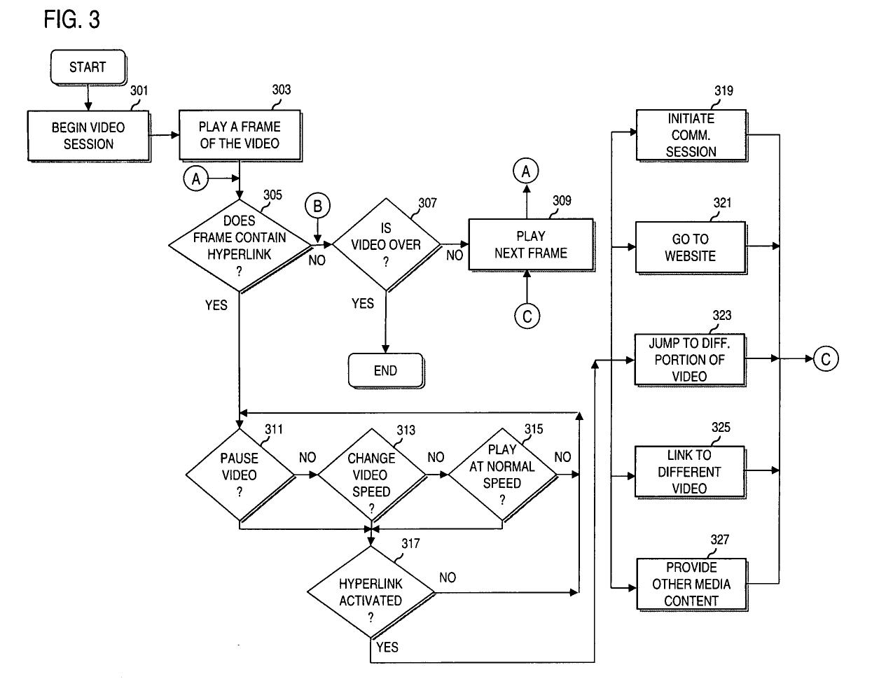

FIG. 3 is a flowchart of a process for providing hyperlinked interactive video, according to an exemplary embodiment. In step 301, a video session is commenced; e.g., a video program is played at a set-top box (e.g., set-top box 201a). The set-top box 201a can accept streaming audio and video from the A/V streaming server 221, and interpret and display the video signal using various mechanisms, such as Real-Time Protocol (RTP) streams, HyperText Transfer Protocol (HTTP) based streams, etc. During this playback (step 303), a determination is made, per step 305, whether the particular frame contains a hyperlink; in one embodiment, this determination is performed on a frame-by-frame basis. If not, the process then determines whether the video program is over, per step 307. If the video program is over (i.e., particular frame is the last frame), then the process ends.

However, if the video program is not yet completed, then the next frame of the video is played at step 309; and, again, a determination is made as to whether this next frame includes a hyperlink. When such a hyperlink exists, the process determines what action the video program will take in conjunction with such a determination. For example, the type of action to be taken can be predetermined in the session setup by the communication information between the RTSP server 223 and the application resident in the set-top box 201a. Alternatively, the type of action can be determined during the playing of the video stream in conjunction with preset instructions. Thus, in response to an affirmative response to the finding of a hyperlink, the process determines whether to pause (step 311), change video speed (step 313) or play at normal speed (step 315). For example, if it has been predetermined that a detection of a hyperlink in a frame of the video will result in the video being paused until the user takes some action, the video stream would be frozen until the hyperlink is activated or the user overriding the pausing by pressing “play” on the remote control device 225. In the case where the video's response to the appearance of a hyperlink in a frame is to either vary the speed of the video or continue at normal speed, if no action is taken by the user, e.g., there is no activation of the hyperlink, the video will play on, albeit possibly at a changed speed (e.g., slower) until a frame is reached wherein the hyperlink is no longer displayed and, at that time, the video may resume its normal playing speed.

In step 317, the process checks whether the hyperlink is activated; for example, by selection of the text or graphic representing the hyperlink by the user with a remote control device 225. If an activation of the hyperlink has occurred, then a particular action is taken in accordance with predetermined instructions and the type of hyperlink and program with which the hyperlink is associated. It is noted that the action of the video will typically have been predetermined, so that rather than proceeding through the determination steps 311, 313 and 315, the process can skip such steps to proceed to step 317.

As shown, activation of the hyperlink can entail any number of actions. For example, the hyperlink can initiate placement of a communication session (e.g., telephone call), per step 319. The hyperlink may specify a Uniform Resource Location (URL), wherein the user is provided with an online connection to a website, as in step 321. In addition, the hyperlink may permit the user to scrub about the video stream (step 323) or transfer to other media content, such as another video program, a website, etc. (steps 325 and 327).

For the purposes of illustration, the video program, during a series of frames, may represent an advertisement for a commercial product or it may be a public service announcement, either one of which may have a telephone number associated with the hyperlink. Under this scenario, activation of the hyperlink initiates a call to a telephone number, as in step 319, which can be to a call center of the advertiser. In addition, another hyperlink can “take” the user to the website of the advertiser, per step 321. The hyperlink may also be associated with another portion of the currently playing video or a different video program all together. By way of example, the selected section provides more detail of an object corresponding to the hyperlink. In this instance, the hyperlink stores a timestamp corresponding to the section with such details. For example, if the subject of the advertisement is cars, multiple hyperlinks may appear underneath the respective cars in the video, whereby activation of the particular hyperlink permits the user to jump a video portion that describes the particular car of interest. Alternatively, the activation of the hyperlink may invoke a menu of other video programs related to the selected car.

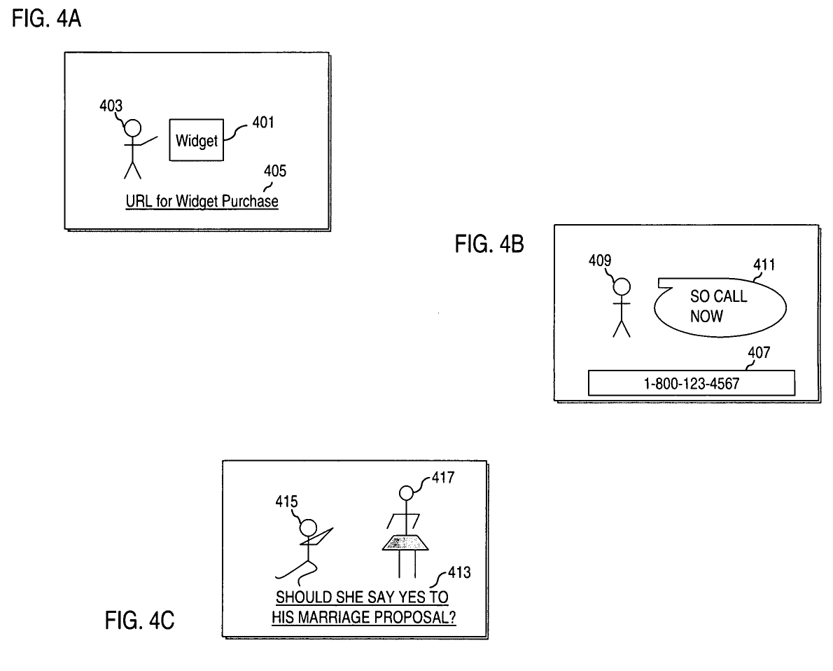

Other scenarios are shown in FIGS. 4A-4C, whereby the interactive hyperlink video service is utilized.

FIGS. 4A-4C are diagrams of exemplary video frames containing embedded hyperlinks, according to various embodiments. As seen in FIG. 4A, if an action on the hyperlink is to redirect the user to a web page that is to be displayed on the communication device display device or a web service, then the URL of the web page or web service may be displayed as a hyperlink. For example, a commercial product 401 is displayed by a model 403 in a video segment. A hyperlink 405 specifying the URL of the product 401 is displayed on the frame(s) of the video displaying the commercial advertisement. If the user is interested in purchasing this product 401, the user can activate the hyperlink 405 by selecting the link to invoke a browser application to access the website. The website is then displayed to the user using the same display (e.g., television set). The user may then purchase the product using the website. At this point, the video program can be halted, so that the user is returned to the program after visiting the website.

In FIG. 4B, the hyperlink 407 is to a telephone number associated with an announcer 409 providing an audio message 411. The situation may be, for example, a public service announcement, indicating a telephone number to call for more information about a specific topic. The action of an interested user may be to click on or otherwise activate the hyperlink 407 to dial a telephone number. The telephone call can then be conducted through the set-top box 201a and the associated display.

As another example (FIG. 4C), the user is invited to interactively participate in the video program, such as a reality television program, by using an associated hyperlink 413 to affect the outcome of the program. The hyperlink 413 may cause jumping to another point in the same video or to a point in a different video, providing, for example, interactivity between the video and the user. In the example of FIG. 4C, there is a scene in a video where participant A 415 is asking participant B 417 to marry him. By the appropriate activation of the hyperlink 413, the user can indicate the user's support of the marriage: “yes” or “no.”

The processes described herein for providing hyperlinked interactive video may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

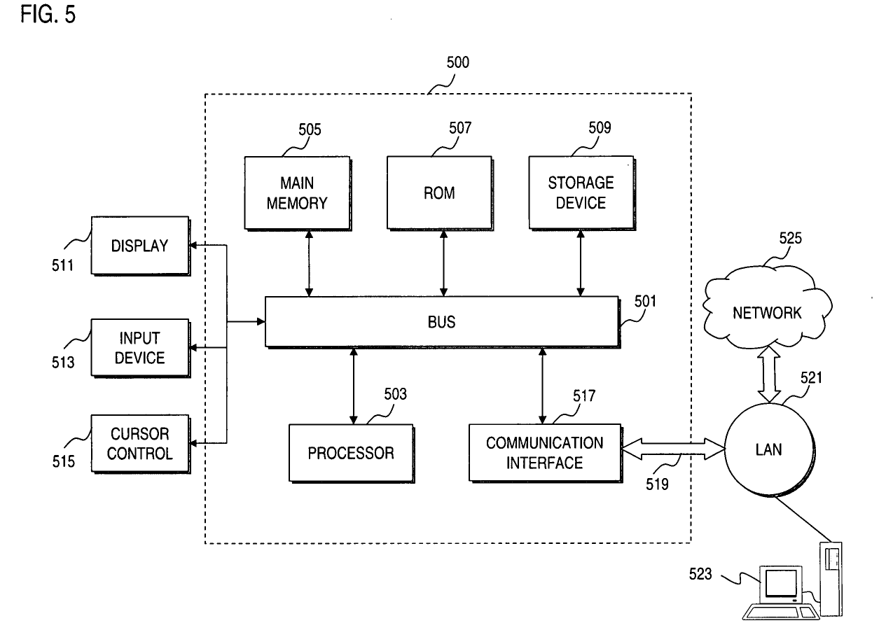

FIG. 5 illustrates a computer system 500 upon which an embodiment according to an exemplary embodiment can be implemented. For example, the processes described herein can be implemented using the computer system 500. The computer system 500 includes a bus 501 or other communication mechanism for communicating information and a processor 503 coupled to the bus 501 for processing information. The computer system 500 also includes main memory 505, such as a random access memory (RAM) or other dynamic storage device, coupled to the bus 501 for storing information and instructions to be executed by the processor 503. Main memory 505 can also be used for storing temporary variables or other intermediate information during execution of instructions by the processor 503. The computer system 500 may further include a read only memory (ROM) 507 or other static storage device coupled to the bus 501 for storing static information and instructions for the processor 503. A storage device 509, such as a magnetic disk or optical disk, is coupled to the bus 501 for persistently storing information and instructions.

The computer system 500 may be coupled via the bus 501 to a display 511, such as a cathode ray tube (CRT), liquid crystal display, active matrix display, or plasma display, for displaying information to a computer user. An input device 513, such as a keyboard including alphanumeric and other keys, is coupled to the bus 501 for communicating information and command selections to the processor 503. Another type of user input device is a cursor control 515, such as a mouse, a trackball, or cursor direction keys, for communicating direction information and command selections to the processor 503 and for controlling cursor movement on the display 511.

According to one embodiment contemplated herein, the processes described are performed by the computer system 500, in response to the processor 503 executing an arrangement of instructions contained in main memory 505. Such instructions can be read into main memory 505 from another computer-readable medium, such as the storage device 509. Execution of the arrangement of instructions contained in main memory 505 causes the processor 503 to perform the process steps described herein. One or more processors in a multi-processing arrangement may also be employed to execute the instructions contained in main memory 505. In alternative embodiments, hard-wired circuitry may be used in place of or in combination with software instructions to implement certain embodiments. Thus, the exemplary embodiments are not limited to any specific combination of hardware circuitry and software.

The computer system 500 also includes a communication interface 517 coupled to bus 501. The communication interface 517 provides a two-way data communication coupling to a network link 519 connected to a local network 521. For example, the communication interface 517 may be a digital subscriber line (DSL) card or modem, an integrated services digital network (ISDN) card, a cable modem, a telephone modem, or any other communication interface to provide a data communication connection to a corresponding type of communication line. As another example, communication interface 517 may be a local area network (LAN) card (e.g. for Ethernet™ or an Asynchronous Transfer Model (ATM) network) to provide a data communication connection to a compatible LAN. Wireless links can also be implemented. In any such implementation, communication interface 517 sends and receives electrical, electromagnetic, or optical signals that carry digital data streams representing various types of information. Further, the communication interface 517 can include peripheral interface devices, such as a Universal Serial Bus (USB) interface, a PCMCIA (Personal Computer Memory Card International Association) interface, etc. Although a single communication interface 517 is depicted in FIG. 5, multiple communication interfaces can also be employed.

The network link 519 typically provides data communication through one or more networks to other data devices. For example, the network link 519 may provide a connection through local network 521 to a host computer 523, which has connectivity to a network 525 (e.g. a wide area network (WAN) or the global packet data communication network now commonly referred to as the “Internet”) or to data equipment operated by a service provider. The local network 521 and the network 525 both use electrical, electromagnetic, or optical signals to convey information and instructions. The signals through the various networks and the signals on the network link 519 and through the communication interface 517, which communicate digital data with the computer system 500, are exemplary forms of carrier waves bearing the information and instructions.

The computer system 500 can send messages and receive data, including program code, through the network(s), the network link 519, and the communication interface 517. In the Internet example, a server (not shown) might transmit requested code belonging to an application program for implementing an exemplary embodiment through the network 525, the local network 521 and the communication interface 517. The processor 503 may execute the transmitted code while being received and/or store the code in the storage device 509, or other non-volatile storage for later execution. In this manner, the computer system 500 may obtain application code in the form of a carrier wave.

The term “computer-readable medium” as used herein refers to any medium that participates in providing instructions to the processor 503 for execution. Such a medium may take many forms, including but not limited to non-volatile media, volatile media, and transmission media. Non-volatile media include, for example, optical or magnetic disks, such as the storage device 509. Volatile media include dynamic memory, such as main memory 505. Transmission media include coaxial cables, copper wire and fiber optics, including the wires that comprise the bus 501. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out various embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
generating a hyperlink specifying an action to be performed upon activation of the hyperlink; and
embedding the hyperlink in a video stream.

2. A method as recited in claim 1, wherein appearance of the hyperlink in the video stream changes playing speed of the video stream.

3. A method according to claim 2, wherein the playing speed of the video stream is made slower than a normal playing speed.

4. A method according to claim 1, wherein the video stream is either fast forwarded, rewound, or paused.

5. A method according to claim 1, wherein an activation of the hyperlink causes a display of an associated webpage or media content other then the video stream.

6. A method according to claim 1, wherein an activation of the hyperlink causes a display of another video stream different from the video stream.

7. A method according to claim 1, wherein an activation of the hyperlink causes a display of another portion of the video stream.

8. A method according to claim 1, wherein the hyperlink is activated via a remote control device.

9. An apparatus comprising:
a processor configured to generate a hyperlink specifying an action to be performed upon activation of the hyperlink, wherein the hyperlink is embedded in a video stream.

10. An apparatus as recited in claim 9, wherein appearance of the hyperlink in the video stream changes playing speed of the video stream.

11. An apparatus according to claim 9, wherein the playing speed of the video stream is made slower than a normal playing speed.

12. An apparatus according to claim 9, wherein the video stream is either fast forwarded, rewound, or paused.

13. An apparatus according to claim 9, wherein an activation of the hyperlink causes a display of an associated webpage or media content other then the video stream.

14. An apparatus according to claim 9, wherein an activation of the hyperlink causes a display of another video stream different from the video stream.

15. An apparatus according to claim 9, wherein an activation of the hyperlink causes a display of another portion of the video stream.

16. An apparatus according to claim 9, wherein the hyperlink is activated via a remote control device.

17. A method comprising:
associating a hyperlink with a video program;
transmitting the video program including the hyperlink to a set-top box of a subscriber, wherein the hyperlink is selectively presented along with the video program to the subscriber via a display coupled to the set-top box, and upon activation of the hyperlink by the subscriber, an action associated with the hyperlink is performed.

18. A method according to claim 17, wherein the hyperlink is activated by user using a remote control device configured to communicate with the set-top box.

19. A method according to claim 17, wherein the hyperlink includes a Uniform Resource Locator (URL).

20. A method according to claim 17, wherein the hyperlink specifies a telephone number, and the activation initiates a call to the telephone number.

21. A method according to claim 17, wherein the hyperlink specifies a timestamp associated with another portion of the video program, and the activation changes display of the video program to a video frame associated with the timestamp.

22. A system comprising:
a video server configured to associate a hyperlink with a video program, and to transmit the video program including the hyperlink to a set-top box of a subscriber, wherein the hyperlink is selectively presented along with the video program to the subscriber via a display coupled to the set-top box, and upon activation of the hyperlink by the subscriber, an action associated with the hyperlink is performed.

23. A system according to claim 22, wherein the hyperlink is activated by the subscriber using a remote control device configured to communicate with the set-top box.

24. A system according to claim 22, wherein the hyperlink includes a Uniform Resource Locator (URL).

25. A system according to claim 22, wherein the hyperlink specifies a telephone number, and the activation initiates a call to the telephone number.

26. A system according to claim 22, wherein the hyperlink specifies a timestamp associated with another portion of the video program, and the activation changes display of the video program to a video frame associated with the timestamp.
